(19) United States
(12) Patent Application Publication
(10) Pub. No.: US 2026/0108400 A1
(43) Pub. Date: Apr. 23, 2026

(54) AIRCRAFT MOBILITY LIFT APPARATUS AND METHOD

(71) Applicant: Kruckeberg Industries, LLC, Blooming Prairie, MN (US)

(72) Inventors: Craig Kruckeberg, Blooming Prairie, MN (US); Cash Kruckeberg, Blooming Prairie, MN (US)

(21) Appl. No.: 19/360,043

(22) Filed: Oct. 16, 2025

Related U.S. Application Data
(60) Provisional application No. 63/709,117, filed on Oct. 18, 2024.

(51) Int. Cl. A61G 3/06; B66F 7/28

(52) U.S. Cl. CPC A61G 3/063; B66F 7/28

(57) ABSTRACT

The present disclosure relates to a mobility lift configured to assist individuals with limited mobility in navigating obstacles, such as aircraft stairs. The lift includes a platform serving as the primary support surface, capable of moving between lowered and elevated positions. A motor, potentially electrical and battery-powered, facilitates the lift's vertical transitions. Incorporated manual lift means provide operational capability in the event of a power failure. The system is mounted on casters for maneuverability, includes a foot brake for secure positioning, and features extensible platform elements with safety lockout devices. Handrails with extensions and pivot locks are included for user support, and a collapsible seat offers optional seating. A control panel with a remote module allows for both direct and remote operation. Additionally, stabilizing legs offer enhanced stability. The lift's adaptable design accommodates various accessibility challenges, including passenger transport and luggage handling.

### RELATED APPLICATIONS

The present application claims priority to and incorporated by reference United States Provisional Patent Application No. 63,709,117 filed on Oct. 18, 2024.

### BACKGROUND OF THE INVENTION

### Field of the Invention

The present invention relates to a method and apparatus for transporting a passenger into and out of an aircraft, and in particular a person having mobility limitations who are boarding a small aircraft such as private planes; provided, however, that a person of ordinary skill in the art will understand that the invention is not necessarily limited thereto.

### Background

Devices to assist with the loading of passengers, equipment, and luggage into aircraft and other transportation means are known in the art. Aircraft use a variety of devices for this purpose. Most airports of size have walkways or jetways that allow for passengers to walk from the airport terminal into the door of the aircraft, despite the fact that the aircraft doors are a substantial distance from the ground.

Walkways are partially mobile and have limited movement in multiple axes to accommodate differences in size, height, and distance between an aircraft and the terminal.

Walkways, however, suffer from a number of drawbacks. Not all airports can accommodate walkways. Smaller airports and private airports often do not have the necessary facilities to utilize walkways. Also, walkways as mentioned have limited ability to move and typically cannot move low enough to be used with anything other than large commercial aircraft. Also, walkways are sized to match the size of the door of large commercial aircraft which are far larger than the doors of smaller or private aircraft.

Smaller aircraft then have to use stairs to load and unload passengers, and in many cases the stairs are built into the door of the aircraft. As such, whenever the door is open the stairs are deployed and they cannot be moved out of the way. This can be an obstacle to persons of limited mobility as they may not be able to traverse stairs, and in some cases might be in a wheelchair or walker. In these situations, neither stairs or walkways are an option, and boarding or deboarding the aircraft becomes very difficult to impossible.

Thus, a need exists for method and apparatus to allow persons of limited mobility to board and deboard smaller aircraft, which solves the problems of the prior art.

### BRIEF DESCRIPTION OF THE FIGURES

FIG. 1 is a side perspective view of a mobility lift.

FIG. 2 is an end perspective view of the mobility lift.

FIG. 3 is a side perspective view of the mobility lift in a raised position.

FIG. 4 is an end perspective view of the mobility lift in a raised position.

FIG. 5 is a side perspective view of the mobility lift with the handrails pivoted away from the lift.

FIG. 6 is an end perspective view of the mobility lift with the handrails pivoted away from the lift.

FIG. 7 is a bottom view of the mobility lift in a raised position.

FIG. 8 is a top view of the mobility lift in a raised position.

FIG. 9 is a side view of the mobility lift in a raised position.

FIG. 10 is an end view of the mobility lift in a raised position.

FIG. 11 is a bottom view of the mobility lift in a lowered position.

FIG. 12 is a top view of the mobility lift in a lowered position.

FIG. 13 is a side view of the mobility lift in a lowered position.

FIG. 14 is an end view of the mobility lift in a lowered position.

FIG. 15 is a perspective view of the mobility lift adjacent to an aircraft.

FIG. 16 is a perspective view of the mobility lift controls.

### SUMMARY OF THE INVENTION

The subject matter pertains to a mobility lift designed to aid individuals with limited mobility in overcoming obstacles such as aircraft stairs. This lift includes a platform that serves as the primary support and can move vertically between different positions. An electric motor powers the lift, with an option for manual operation in case of a power outage. The system is equipped with casters for mobility, a foot brake for stability, and an extendable platform with a safety lockout feature. It includes handrails with extensions and pivot locks for added support, as well as a folding seat for optional use. A control panel and remote control module provide both direct and remote operating capabilities. Stabilizing legs are integrated to enhance stability. The design allows for flexibility in use, catering to various accessibility needs such as passenger and equipment transport.

### DETAILED DESCRIPTION OF THE PREFERRED EMBODIMENTS

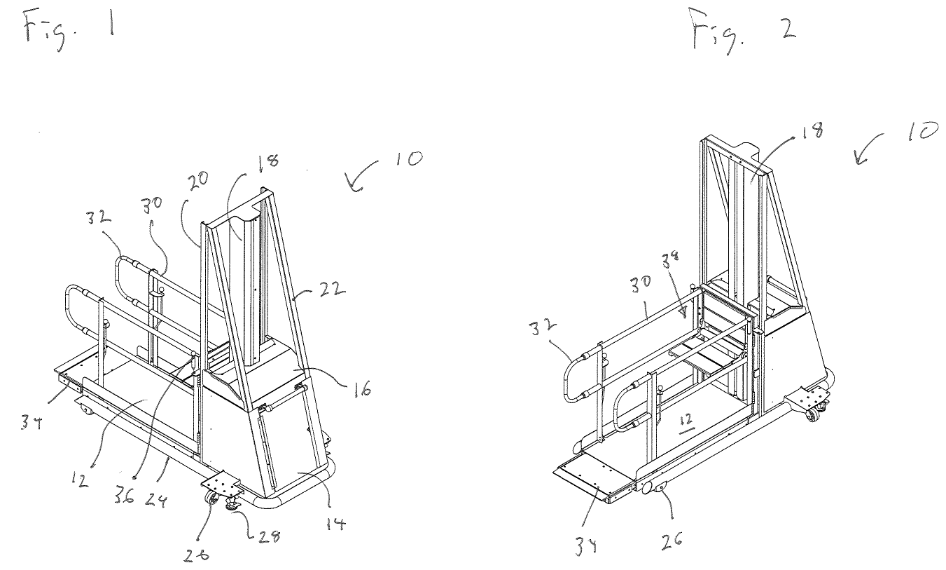

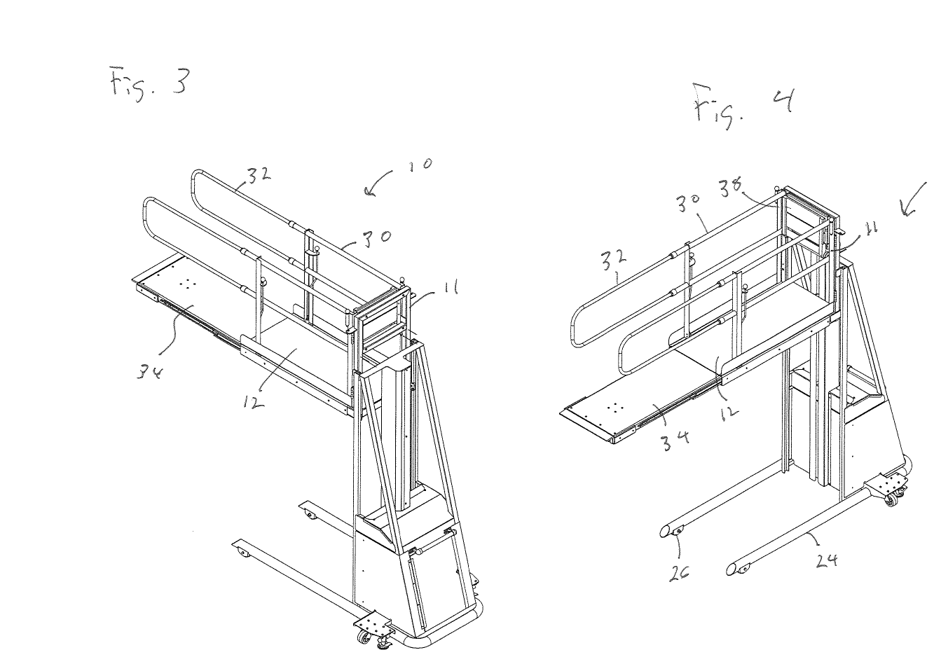

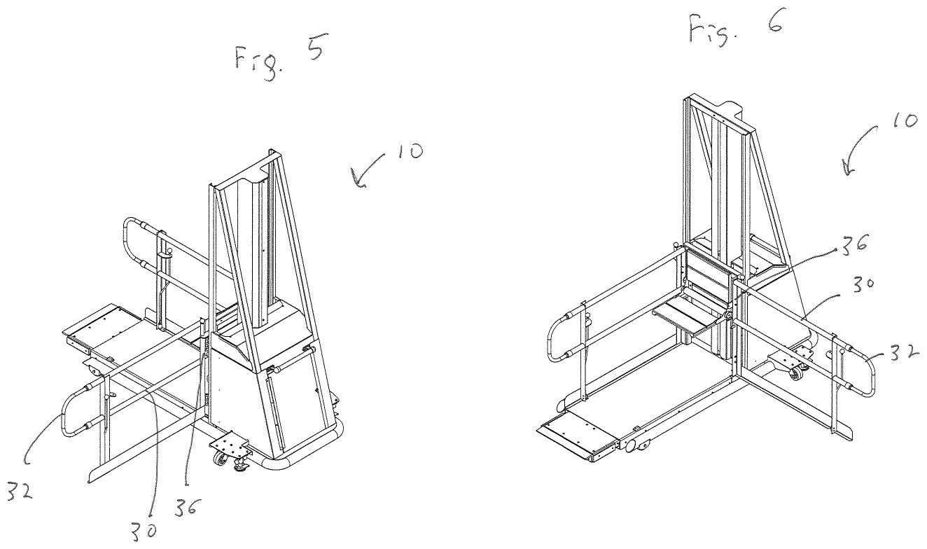

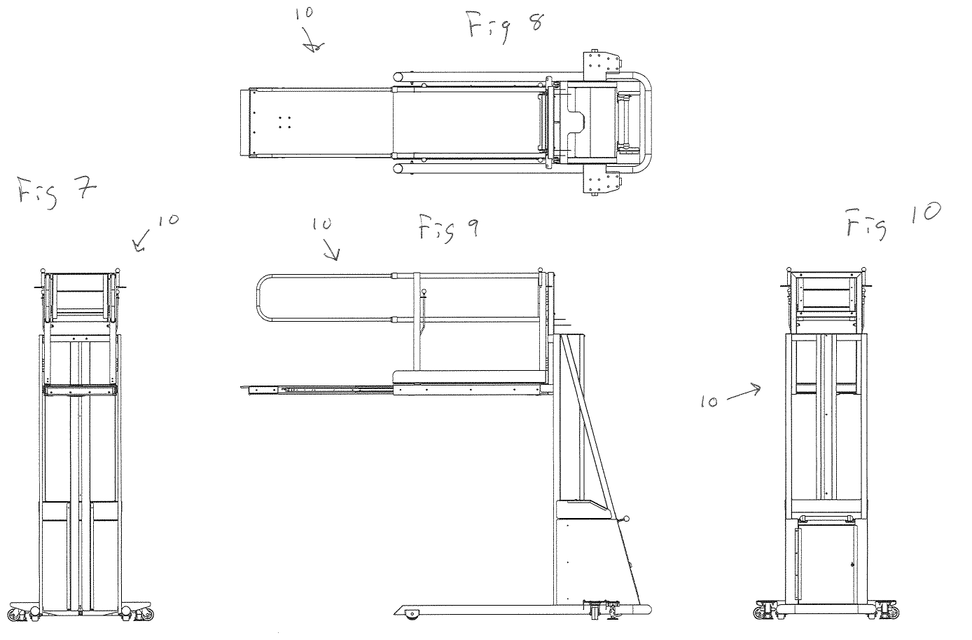

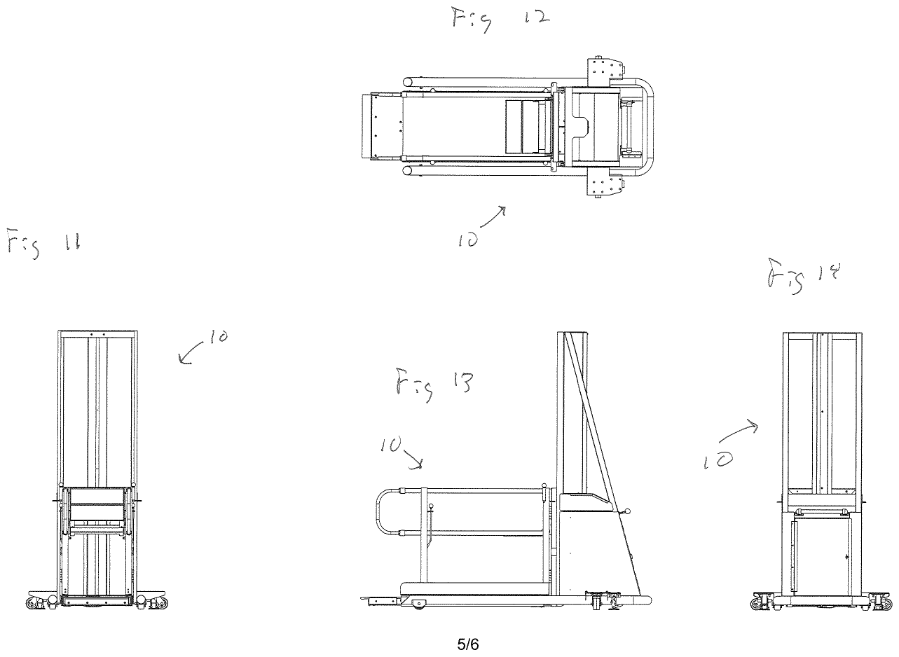

In the Figures, a mobility lift 10 is shown. The lift 10 is powered by a motor (not shown) that is housed in a storage compartment 14. Preferably, the motor is electrical and powered by a battery located in the storage compartment 14, however, other types of motors and power are contemplated. The motor moves the lift 10 between a first lowered position shown in FIG. 1, and a second elevated position shown in FIG. 3.

The lift 10 comprises a platform 12. Handrails 30 secure to the platform 12, and both the handrails 30 and the platform 12 secure to lift brackets 11. The platform 12, handrails 30, and the lift brackets 11 move up and down between the first and second positions under operation of the motor. The motor propels a lift device located inside the lift frame 18 (such as a screw drive or other similar means). A manual lift means is included in the storage compartment 14 to operate the lift 10 by hand if power is not available. Lift rails 20 provide support to the platform 12, handrails 30, and the lift brackets 11 as they move between the first and second positions. Further support to the lift rails 20 is provided by support rails 22.

The lift 10 comprises a platform 12. Handrails 30 secure to the platform 12, and both the handrails 30 and the platform 12 secure to lift brackets 11. The platform 12, handrails 30, and the lift brackets 11 move up and down between the first and second positions under operation of the motor. The motor propels a lift device located inside the lift frame 18 (such as a screw drive or other similar means). A manual lift means is included in the storage compartment 14 to operate the lift 10 by hand if power is not available. Lift rails 20 provide support to the platform 12, handrails 30, and the lift brackets 11 as they move between the first and second positions. Further support to the lift rails 20 is provided by support rails 22.

The lift 10 is mounted on casters 26 that allow it to be easily moved as needed, either by hand or by a machine. A foot brake 28 is provided to lock the lift 10 in place during operation or storage, or otherwise as needed.

The platform 12 includes a platform extension 34 that telescopes outward from the platform 12 to extend the length of the lift 10. The extension 34 includes a pressure sensitive lockout device for safety purposes that stops the extension 34 from moving when weight is placed on it. The handrails 30 include handrail extensions 32 that extend with the platform extension 34. One or both of the handrails 30 include a hand rial pivot lock 36 that allows the handrail 30 to pivot between the positions shown in FIGS. 5 and 1, such that the handrail 30 is securely locked in either position.

The lift 10 also includes a folding seat 38 located on the platform 12.

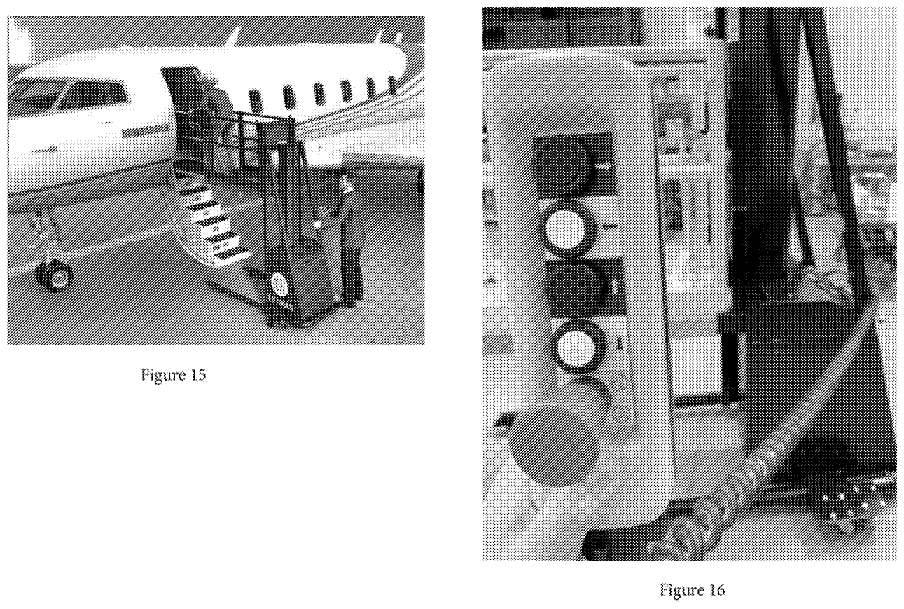

The lift 10 includes a control panel space 16 that houses a controls for operating the lift 10. In operation the lift 10 can be operated as shown in FIG. 15. As noted above, smaller aircraft typically have stairs that are part of the door and cannot be removed, which presents an obstacle for persons of limited mobility when boarding or deboarding the aircraft.

To use the lift 10, the lift 10 is positioned with the platform 12 in the downward position shown in FIG. 1. A person can board the lift 10, and then sit on the seat 38. If the person is in a wheelchair or walker the seat 38 is retracted along the person to board the lift 10 while remaining in the wheelchair or walker.

Next, the lift 10 is elevated into the upward position shown in FIG. 3, under operation of the motor located in the storage compartment 14. The lift 10 can then be moved into the position shown in FIG. 15, and the person can then enter the plane bypassing the stairs. The platform extension 34 and the handrail extensions 32 can be extended either before or after the person boards the lift 10 as necessary to align the lift 10 with the plane opening.

As shown in FIG. 16, a remote operating control module is provided. The module is connected with a cord to the control panel 16, or it can be connected wirelessly. The module has four controls that move the platform 12 vertically up or down, and to move the platform extension 34 horizontally in and out. The module has an emergency stop button to use to stop all movement in case of an emergency.

The present invention is not necessarily limited to use with passengers, but can also be adapted for and used with luggage, equipment, and the like. A further feature of the present invention is the ability of the platform 12 legs 24 to pivot outward to better stabilize the lift 10.

To summarize, the invention pertains to a mobility lift, referred to herein as lift 10, which is configured to assist individuals with limited mobility in navigating obstacles such as aircraft stairs. The lift 10 is equipped with several structural components and functionalities aimed at enhancing accessibility and safety.

### Lift Construction and Components:

1. Platform 12: Central to the lift structure, the platform 12 serves as the primary support surface. It is coupled with lift brackets 11, which, along with handrails 30, move vertically between a lowered position (FIG. 1) and an elevated position (FIG. 3).
2. Motor and Power Source: A motor, preferably electrical and battery-powered, is housed in storage compartment 14. It facilitates the transition of lift 10 between different vertical positions. Alternative motor types and power sources are contemplated.
3. Manual Lift Means: In the event of a power failure, a manual lift mechanism located in the storage compartment 14 allows for manual operation of the lift.
4. Lift Rails and Support Rails: Lift rails 20 provide foundational support for the elevating components, while support rails 22 reinforce the lift rails 20 during movement.
5. Mobility Features: Mounted on casters 26, the lift 10 can be maneuvered easily. A foot brake 28 is integrated to secure the lift in place as needed.
6 Platform Extension 34: Extending telescopically from platform 12, this extension allows adjustment of the platform's length. It includes a pressure-sensitive lockout device, enhancing safety by halting movement when weight is detected.
7. Handrail Extensions 32 and Pivot Lock 36: The handrails 30 extend with the platform and include a pivot lock 36 for secure positioning as shown in FIGS. 5 and 1.
8. Folding Seat 38: A collapsible seat is provided on the platform for use by individuals who may not need or prefer seating.
9. Control Panel and Remote Module: The control panel space 16 accommodates controls for lift operation. A remote module, either corded or wireless, enables remote control of the lift vertical and horizontal positioning and includes an emergency stop feature.
10. Stabilizing Legs 24: The platform legs have a pivot capability to provide additional stabilization.

### Operation

During operation, the lift 10 is aligned in a downward position to permit boarding. The individual may choose to sit or remain in mobility aids like wheelchairs, in which case the seat 38 can retract. The platform 12, driven by the motor, then elevates to the desired height for boarding aircraft, bypassing stairs. The platform extension 34 and handrail extensions 32 are adjustable to align with the aircraft door.

### Applications

Beyond passenger use, lift 10 is adaptable for transporting luggage and equipment. Its structural adaptability and comprehensive control features make it suitable for various accessibility challenges in different settings.

Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods, and materials are described below. All publications, patent applications, patents, and other references mentioned herein are incorporated by reference in their entirety to the extent allowed by applicable law and regulations. In case of conflict, the present specification, including definitions, will control.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention. Those of ordinary skill in the art that have the disclosure before them will be able to make modifications and variations therein without departing from the scope of the invention.

1) A mobility lift comprising:
i) a platform configured as a primary support surface;
ii) lift brackets coupled to the platform, facilitating movement between a lowered position and an elevated position;
iii) an electric motor housed within a storage compartment, operatively connected to facilitate vertical transitions of the lift;
iv) a manual lift mechanism located in the storage compartment, providing manual operation capability;
v) lift rails supporting the elevating components;
vi) support rails reinforcing the lift rails;
vii) casters attached to the mobility lift for maneuverability;
viii) a foot brake integrated for securing the mobility lift;
ix) a platform extension telescopically extendable from the platform, incorporating a pressure-sensitive lockout device;
x) handrails extending with the platform, configured with pivot locks;
xi) a collapsible seat situated on the platform;
xii) a control panel with a remote module for controlling the lift's vertical and horizontal positioning, including an emergency stop feature; and
xiii) stabilizing legs pivotally attached for providing additional stabilization.

2) The mobility lift of claim 1, wherein the motor is battery-powered.

3) The mobility lift of claim 1, further comprising:
i) handrail extensions adjustable in alignment with the platform extension.

4) The mobility lift of claim 1, wherein the remote module is selected from the group consisting of corded and wireless modules.

5) The mobility lift of claim 1, wherein the platform extension adjusts to align with an aircraft door.

6) The mobility lift of claim 1, wherein the collapsible seat is retractable to accommodate mobility aids.

7) The mobility lift of claim 1, further comprising stabilizing legs, wherein the legs are pivotally adjustable to enhance stability during lift operation.

8) The mobility lift of claim 1, wherein the foot brake is configured to secure the mobility lift during operation on an inclined surface.

9) The mobility lift of claim 1, wherein the pressure-sensitive lockout device halts platform movement upon weight detection.
